(19) United States
(12) Patent Application Publication
(10) Pub. No.: US 2026/0054798 A1
(43) Pub. Date: Feb. 26, 2026

(54) CONTROL SYSTEM AND HUMAN-POWERED VEHICLE

(71) Applicant: Satoshi SHAHANA, Osaka (JP)

(72) Inventor: Satoshi SHAHANA, Osaka (JP)

(73) Assignee: Shimano Inc., Osaka (JP)

(21) Appl. No.: 19/230,920

(22) Filed: Jun. 6, 2025

(30) Foreign Application Priority Data
Aug. 22, 2024 (JP) 2024-140832

(51) Int. Cl. B62M 6/50; B62M 25/08

(52) U.S. Cl. CPC B62M 6/50; B62M 25/08

(57) ABSTRACT

A control system includes at least one sensor configured to detect detection information regarding a traveling state of a human-powered vehicle, and a controller configured to control a motor and at least one transmission. A shift operation by the at least one transmission includes a first shift operation involving driving of a chain by the motor. The controller is configured to selectively stop or continue driving of the motor in accordance with a first detection result of the at least one sensor in a case where a shifter is operated during the first shift operation.

### CROSS-REFERENCE TO RELATED APPLICATIONS

This application claims priority to Japanese Patent Application No. 2024-140832, filed on Aug. 22, 2024. The entire disclosure of Japanese Patent Application No. 2024-140832 is hereby incorporated herein by reference.

### BACKGROUND

### Technical Field

The present disclosure generally relates to a control system and a technique of a human-powered vehicle.

### Background Information

Control systems for controlling a human-powered vehicle have been known. For example, International Publication No. WO 2011/158220 A2 (hereinafter referred to as Patent Document 1) discloses a control system that controls a motor configured to apply a propulsion force to a human-powered vehicle so that the motor is stopped immediately before shifting.

### SUMMARY

One object of the present disclosure is to provide a control system capable of contributing to comfortable traveling of a human-powered vehicle, and a human-powered vehicle.

A control system according to a first aspect of the present disclosure includes a at least one sensor configured to detect detection information regarding a traveling state of a human-powered vehicle, and a controller configured to control a motor and at least one transmission. The at least one transmission includes a first shift operation involving driving of a chain by the motor. The controller is configured to selectively stop or continue driving of the motor in accordance with a first detection result of the at least one sensor in a case where a shifter is operated during the first shift operation.

According to the control system of the first aspect, the control system can contribute to comfortable traveling of the human-powered vehicle.

In the control system of a second aspect according to the first aspect, the controller is configured to execute first processing of stopping the driving of the motor to stop the first shift operation before performing the shift operation in response to an operation of the shifter during the first shift operation in a case where the first detection result is equal to or greater than a predetermined threshold, and is the controller is configured to execute second processing of continuing the driving of the motor to continue the first shift operation in a case where the first detection result is less than the threshold.

According to the control system of the second aspect, after stopping the driving of the motor, the gear ratio of the human-powered vehicle can be changed to a gear ratio corresponding to the operation on the shifter.

In the control system of a third aspect according to the second aspect, the at least one transmission includes a second shift operation not involving the driving of the chain by the motor. After stopping the first shift operation in the first processing, the controller is configured to perform, in accordance with a second detection result detected by the at least one sensor, one of the first shift operation in response to an operation of the shifter during the first shift operation and the second shift operation in response to an operation of the shifter during the first shift operation.

According to the control system of the third aspect, after the first shift operation is stopped, one of the first shift operation and the second shift operation can be performed in accordance with the second detection result.

In the control system of a fourth aspect according to the second aspect, in the second processing, after completion of the first shift operation, the controller is configured to perform the shift operation by the at least one transmission in response to an operation of the shifter during the first shift operation.

According to the control system of the fourth aspect, after the completion of the first shift operation, the gear ratio of the human-powered vehicle can be changed to a gear ratio corresponding to the operation on the shifter.

In the control system of a fifth aspect according to the fourth aspect, the at least one transmission includes a second shift operation not involving the driving of the chain by the motor. After completion of the first shift operation in the second processing, the controller is configured to perform, in accordance with a third detection result detected by the at least one sensor, one of the first shift operation in response to an operation of the shifter during the first shift operation and the second shift operation in response to an operation of the shifter during the first shift operation.

According to the control system of the fifth aspect, after the completion of the first shift operation, one of the first shift operation and the second shift operation can be performed in accordance with the second detection result.

In the control system of a sixth aspect according to the fourth aspect, the at least one sensor includes at least one of a pedal sensor configured to detect pedaling of the human-powered vehicle, a vehicle speed sensor configured to detect a vehicle speed of the human-powered vehicle, and a tilt sensor configured to detect an inclination of the human-powered vehicle. The controller is configured to perform one of the first processing and the second processing in accordance with the first detection result of the at least one sensor.

According to the control system of the sixth aspect, one of the first processing and the second processing is performed in accordance with any one of the pedaling, the vehicle speed, and the inclination of the human-powered vehicle.

A control system according to a seventh aspect of the present disclosure includes a at least one sensor configured to detect detection information regarding a traveling state of a human-powered vehicle, and a controller configured to control a motor and at least one transmission. The at least one transmission includes a first shift operation involving driving of a chain by the motor. In a case where a pedal is operated during the first shift operation, in a case where a first detection result of the at least one sensor is equal to or greater than a predetermined threshold, the controller is configured to execute first processing of stopping driving of the motor to stop the first shift operation before performing the shift operation by the at least one transmission in response to an operation of a shifter during the first shift operation. The controller is configured to execute second processing of continuing the driving of the motor and continuing the first shift operation in a case where the first detection result is less than the threshold.

According to the control system of the seventh aspect, the control system can contribute to comfortable traveling of the human-powered vehicle.

In the control system of an eighth aspect according to the seventh aspect, the at least one sensor includes at least one of a pedal sensor configured to detect pedaling of the human-powered vehicle, a vehicle speed sensor configured to detect a vehicle speed of the human-powered vehicle, and a tilt sensor configured to detect an inclination of the human-powered vehicle. The controller is configured to perform one of the first processing and the second processing in accordance with the first detection result including a detection result of at least one of the pedal sensor, the vehicle speed sensor, and the tilt sensor.

According to the control system of the eighth aspect, any one of the first processing and the second processing is performed in accordance with any one of the pedaling, the vehicle speed, and the inclination of the human-powered vehicle.

A human-powered vehicle according to a ninth aspect of the present disclosure comprises the control system according to any one of the first to eighth aspects, and further includes a shifter operable by a rider, a pedal, a crank mounted with the pedal, a front sprocket rotatable independently of the crank, a rear wheel, a rear sprocket rotatable independently of the rear wheel, a chain meshing with the front sprocket and the rear sprocket, a motor that drives the chain, and at least one transmission that performs a shift operation including a first shift operation involving driving of the chain by the motor.

According to the control system of the eighth aspect, the control system can contribute to comfortable traveling of the human-powered vehicle.

A control system and a human-powered vehicle according to the present disclosure can contribute to comfortable traveling of the human-powered vehicle.

### BRIEF DESCRIPTION OF THE DRAWINGS

Referring now to the attached drawings which form a part of this original disclosure, an illustrative embodiment is shown.

FIG. 1 is a side view illustrating a human-powered vehicle including a control system according to a first embodiment.

FIG. 2 is a cross-sectional view illustrating a drive unit.

FIG. 3 is a block diagram illustrating an electrical configuration of the human-powered vehicle including the control system.

FIG. 4 is a first flowchart of control executed by a controller according to the first embodiment.

FIG. 5 is a second flowchart of the control executed by the controller according to the first embodiment.

FIG. 6 is a first flowchart of control executed by the controller according to a second embodiment.

### DETAILED DESCRIPTION OF EMBODIMENTS

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

### First Embodiment

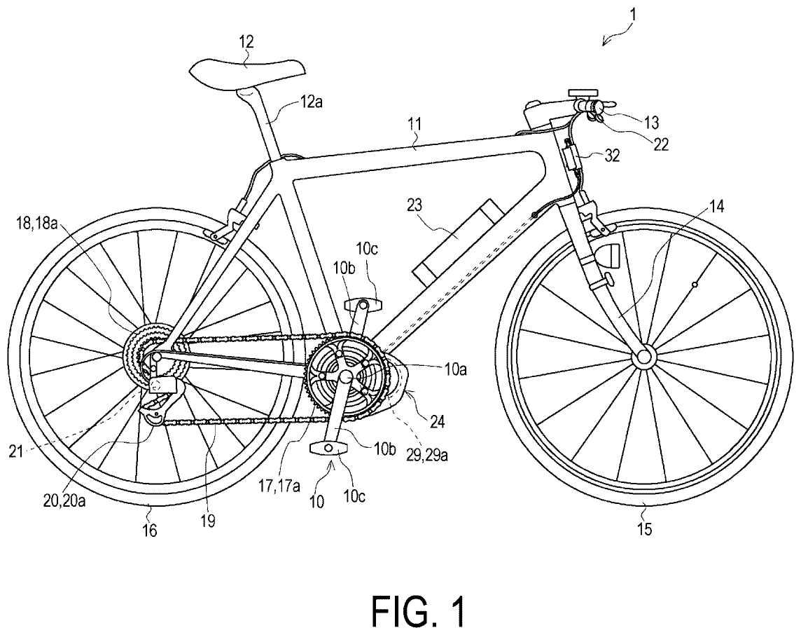

A human-powered vehicle 1 including a control system 33 according to a first embodiment will be described. The human-powered vehicle 1 according to the first embodiment will be described with reference to FIGS. 1 to 5.

The human-powered vehicle 1 is a vehicle that includes at least one wheel and can be driven by at least a human-powered driving force. The human-powered vehicle 1 includes various types of bicycles such as a mountain bicycle, a road bicycle, a city bicycle, a cargo bicycle, a handcycle, and a recumbent bicycle, for example. The number of wheels of the human-powered vehicle 1 is not limited. Examples of the human-powered vehicle 1 include a monocycle and a vehicle including two or more wheels. The human-powered vehicle 1 is not limited to a vehicle that can be driven by only the human-powered driving force. The human-powered vehicle 1 includes an E-bike that uses a driving force of an electric motor in addition to the human-powered driving force for propulsion. The E-bike includes an electrically assisted bicycle, which is assisted in propulsion by the electric motor. Hereinafter, embodiments will be described on the assumption that the human-powered vehicle 1 is an electrically assisted bicycle.

In this present specification, terms indicating the following directions of “front”, “rear”, “forward”, “backward”, “left”, “right”, “lateral”, “upper”, “lower”, and any other similar terms indicating direction are used as terms indicating directions of the human-powered vehicle 1.

The human-powered vehicle 1 includes a pedal 10c, a crank 10 mounted with the pedal 10c, a front sprocket 17a rotatable independently of the crank 10, a rear wheel 16, a rear sprocket 18a rotatable independently of the rear wheel 16, a chain 19 meshing with the front sprocket 17a and the rear sprocket 18a, a motor 29 that drives the chain 19, at least one transmission 20 that performs a shift operation including a first shift operation involving driving of the chain 19 by the motor 29, and the control system 33. In the present embodiment, the shift operation performed by the at least one transmission 20 further includes a second shift operation that does not involve the driving of the chain 19 by the motor 29.

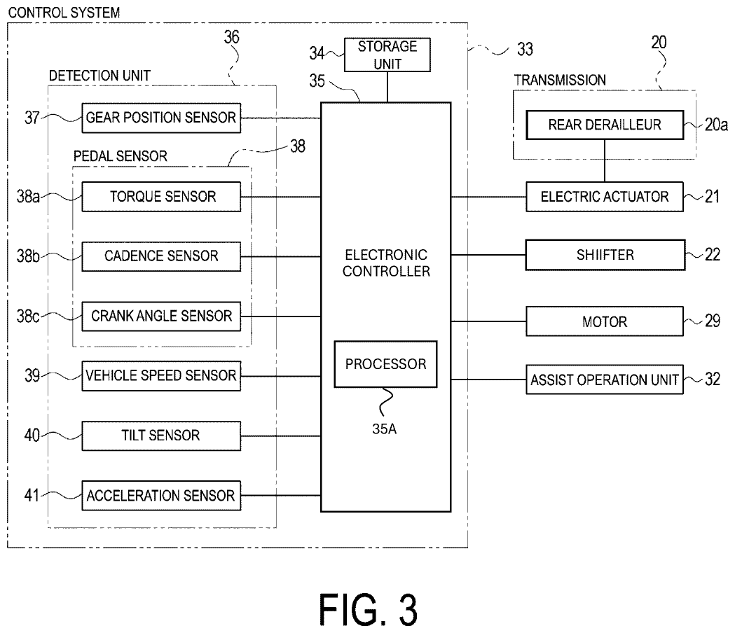

As illustrated in FIGS. 1 and 3, in the present embodiment, the human-powered vehicle 1 further includes a frame 11, a seat 12, a handlebar 13, a front fork 14, a front wheel 15, a first rotation body 17, a second rotation body 18, an electric actuator 21, a shift operation unit or shifter 22, a battery 23, a drive unit 24, and an user operable input device 32. The term “user operable input device” refers to a device that allows users to operate another device.

The crank 10 includes a crankshaft 10a rotatable relative to the frame 11, and a pair of crank arms 10b respectively provided to either end portion of the crankshaft 10a in an axial direction. The pedal 10c is coupled to each crank arm 10b of the pair of crank arms 10b.

The seat 12 is provided to the frame 11 via a seat post 12a. The frame 11 rotatably supports the handlebar 13 and the front fork 14. The handlebar 13 is configured to be grippable by the rider. The handlebar 13 is rotated relative to the frame 11, causing the front fork 14 to rotate, changing a traveling direction of the human-powered vehicle 1.

The front wheel 15 is rotatably attached to the front fork 14. The rear wheel 16 is rotatably attached to the frame 11. The first rotation body 17 is coupled to the crankshaft 10a. The first rotation body 17 includes one of the front sprockets 17a, for example. The first rotation body 17 can include a plurality of the front sprockets 17a. The one front sprocket 17a is configured to rotate with the rotation of the crankshaft 10a in a first rotation direction. The first rotation direction is a direction in which the rear wheel 16 rotates to move forward in a case where the rotation of one front sprocket 17a is transmitted to the rear wheel 16.

The second rotation body 18 is configured to output a human-powered driving force to the rear wheel 16. The second rotation body 18 includes a plurality of the rear sprockets 18a, for example. The second rotation body 18 can include one of the rear sprockets 18a. The plurality of rear sprockets 18a are coupled to the rear wheel 16 via a one-way clutch. The one-way clutch transmits the rotation of the plurality of rear sprockets 18a to the rear wheel 16 in a case where the crankshaft 10a rotates in the first rotation direction, and causes the one front sprocket 17a to rotate, and the plurality of rear sprockets 81a to rotate via the chain 19. The human-powered vehicle 1 advances as a result of the rotation of the plurality of rear sprockets 18a being transmitted to the rear wheel 16. The one-way clutch does not transmit the rotation of the plurality of rear sprockets 18a to the rear wheel 16 in a case where the crankshaft 10a rotates in a second rotation direction opposite to the first rotation direction.

The plurality of rear sprockets 18a can rotate independently of the rear wheel 16 by being coupled to the rear wheel 16 via the one-way clutch. The plurality of rear sprockets 18a can rotate independently of the rear wheel 16, and thus the rotation of the plurality of rear sprockets 18a is not transmitted to the rear wheel 16 in a case where a rotational speed of the rear wheel 16 is faster than a rotational speed of the plurality of rear sprockets 18a.

The transmission 20 includes at least one of an external transmission device and an internal transmission device. In the present embodiment, the transmission 20 includes the external transmission device. In a case where the transmission 20 includes the external transmission device, a gear ratio of the human-powered vehicle 1 is calculated by dividing a number of teeth of the front sprocket 17a with which the chain 19 is meshed, by a number of teeth of the rear sprocket 18a with which the chain 19 is meshed, for example. The external transmission device includes at least one of a front derailleur and a rear derailleur 20a. In the present embodiment, the external transmission device includes the rear derailleur 20a. In a case where the first rotation body 17 includes the plurality of front sprockets 17a, the external transmission device can include the front derailleur.

The electric actuator 21 is configured to operate the rear derailleur 20a. The electric actuator 21 includes, for example, a motor. The electric actuator 21 can further include, for example, a reduction gear coupled to an output shaft of the motor. The electric actuator 21 can be provided to the rear derailleur 20a, or can be provided to a position away from the rear derailleur 20a in the human-powered vehicle 1. As a result of the electric actuator 21 operating the rear derailleur 20a, the chain 19 is switched between the plurality of rear sprockets 18a. The gear ratio of the human-powered vehicle 1 is changed by switching the chain 19 between the plurality of rear sprockets 18a.

The shift operation unit or shifter 22 is configured to be operable by the rider using a hand or a finger. The shift operation unit or shifter 22 is provided to the handlebar 13, for example. The rider operates the shift operation unit or shifter 22, enabling a shift operation for changing the gear ratio of the human-powered vehicle 1.

The battery 23 includes at least one of a non-rechargeable battery and a rechargeable battery, for example. The rechargeable battery is configured to be rechargeable with power from an external power supply. The battery 23 is provided to the frame 11.

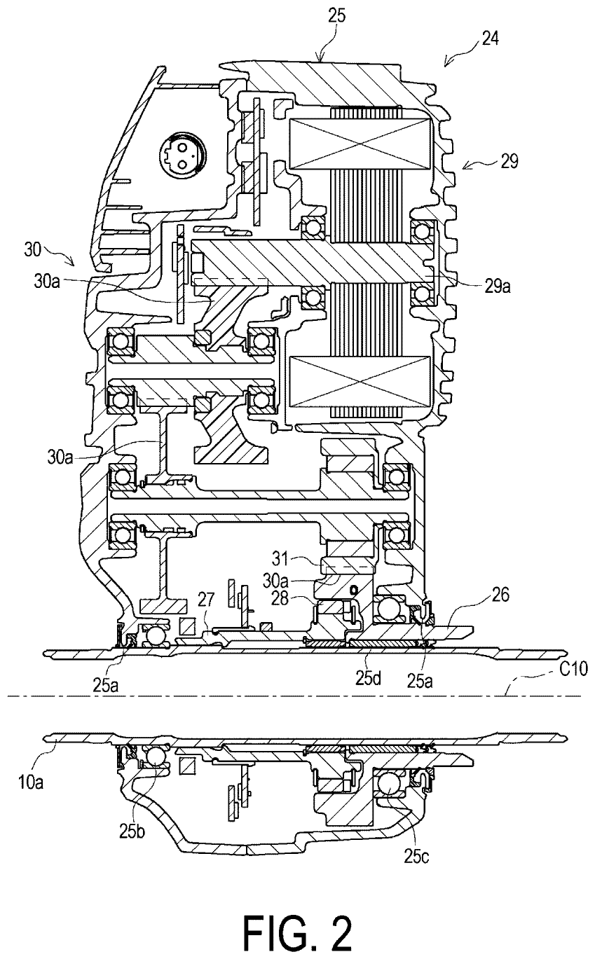

The drive unit 24 is configured to apply a propulsion force to the human-powered vehicle 1 in accordance with the human-powered driving force input to the human-powered vehicle 1. As illustrated in FIG. 2, the drive unit 24 includes a housing 25, an output shaft 26, a transmission shaft 27, a first one-way clutch 28, the motor 29, a reduction gear 30, and a second one-way clutch 31.

The housing 25 is formed in a hollow shape. The housing 25 includes a pair of through holes 25a penetrating through the housing 25 in the axial direction with respect to a rotational center axis C10 of the crankshaft 10a. The crankshaft 10a is inserted through the pair of through holes 25a. The crankshaft 10a protrudes into an external space of the housing 25 via the pair of through holes 25a.

The output shaft 26 is directly or indirectly coupled to the crankshaft 10a. The output shaft 26 has a substantially cylindrical shape. The output shaft 26 is coaxially disposed with the crankshaft 10a. The output shaft 26 is disposed outward of the crankshaft 10a in a radial direction with respect to the rotational center axis C10 of the crankshaft 10a. Part of the output shaft 26 protrudes into the external space of the housing 25 through one of the pair of through holes 25a. The one front sprocket 17a is fixed to the output shaft 26 in the external space of the housing 25. In FIG. 2, the one front sprocket 17a is not illustrated.

The crankshaft 10a is rotatably supported by a first bearing 25b relative to the housing 25. The output shaft 26 is rotatably supported by a second bearing 25c relative to the housing 25. The first bearing 25b and the second bearing 25c are disposed in, for example, an internal space of the housing 25. The output shaft 26 rotatably supports the crankshaft 10a via a third bearing 25d. The third bearing 25d is disposed between an outer peripheral surface of the crankshaft 10a and an inner peripheral surface of the output shaft 26.

The transmission shaft 27 and the first one-way clutch 28 are disposed between the crankshaft 10a and the output shaft 26 in a transmission path of the human-powered driving force from the crankshaft 10a to the plurality of rear sprockets 18a. The transmission shaft 27 is coaxially disposed with the crankshaft 10a. The transmission shaft 27 is fixed to the outer peripheral surface of the crankshaft 10a. Part of the transmission shaft 27 is disposed in an internal space of the output shaft 26. The first one-way clutch 28 is disposed between an outer peripheral surface of the transmission shaft 27 and the inner peripheral surface of the output shaft 26. The first one-way clutch 28 is configured to rotate the one front sprocket 17a in a case where the crankshaft 10a rotates in the first rotation direction, and to allow relative rotation between the crankshaft 10a and the one front sprocket 17a in a case where the crankshaft 10a rotates in the second rotation direction. The one front sprocket 17a can rotate independently of the crank 10 by being coupled to the crankshaft 10a via the first one-way clutch 28.

The motor 29 is configured to apply a propulsion force to the human-powered vehicle 1. The motor 29 is configured to transmit a rotational force to the chain 19 via the output shaft 26, for example. The motor 29 is provided to the housing 25. The motor 29 is disposed in the internal space of the housing 25. The motor 29 includes a motor output shaft 29a.

The reduction gear 30 is configured to couple the motor 29 and the output shaft 26. The reduction gear 30 is provided to the housing 25. The reduction gear 30 is disposed in the internal space of the housing 25. The reduction gear 30 includes, for example, a plurality of outer gears 30a. In a case where the motor output shaft 29a rotates, the plurality of outer gears 30a rotate. With the rotation of the plurality of outer gears 30a, a motor driving force is transmitted to the output shaft 26, and the output shaft 26 rotates. With the rotation of the plurality of outer gears 30a, a rotational speed of the output shaft 26 decreases relative to a rotational speed of the motor output shaft 29a.

The second one-way clutch 31 is provided to the reduction gear 30. The second one-way clutch 31 is configured to transmit the rotation of the motor output shaft 29a to the output shaft 26, and to not transmit the rotation of the output shaft 26 to the motor output shaft 29a.

The user operable input device 32 illustrated in FIG. 1 is configured to be operable by the rider using a hand or a finger. The user operable input device 32 includes, for example, at least one assist switch. The user operable input device 32 is not limited to the assist switch illustrated in FIG. 1, and can include, for example, a button, a switch, a lever, a dial and/or a touch screen. The rider can perform an assist operation for changing the mode of the drive unit 24 by operating the user operable input device 32.

The control system 33 illustrated in FIG. 3 is configured to control the human-powered vehicle 1. The control system 33 further includes at least one sensor configured to detect detection information regarding a traveling state of the human-powered vehicle 1. Here, the control system 33 further includes a detection unit 36 that detects detection information regarding a traveling state of the human-powered vehicle 1. The control system 33 further includes a control unit or controller 35 that controls the motor 29 and the at least one transmission 20. The detection information regarding the traveling state is information indicating the state in which the human-powered vehicle 1 is traveling. The detection information will be described later. In the present embodiment, the control system 33 further includes a storage unit 34.

The storage unit 34 is configured to store a control program and information (e.g., settings, calculations and/or results) used in control processing. The storage unit 34 can also be referred to as memory or a computer storage device. The storage unit 34 is any computer storage device (transitory or non-transitory computer-readable medium) with the sole exception of a transitory propagating signal. The storage unit 34 includes, for example, at least one of a non-volatile memory, a volatile memory, and a hard disk. The non-volatile memory includes, for example, at least one of a read-only memory (ROM), an erasable programmable read-only memory (EPROM), an electrically erasable programmable read-only memory (EEPROM), and a flash memory. The volatile memory includes, for example, a random-access memory (RAM).

The controller 35 can be referred to as an electronic controller 35. The terms “controller” and “electronic controller” as used herein refer to hardware that executes a software program, and does not include a human being. The controller 35 is formed of one or more semiconductor chips that are mounted on a circuit board. The controller 35 is configured to execute control with respect to the control system 33. The controller 35 includes a processor 35A such as an arithmetic processing device that executes a control program determined in advance. The processor 35A or arithmetic processing device includes, for example, a central processing unit (CPU) or a micro processing unit (MPU). The CPU or MPU of the controller 35 can be one or more integrated circuits having firmware for causing the circuitry to execute the predetermined control programs and/or complete the activities described herein. The controller 35 can include one or more microcomputers. The controller 35 further includes an inverter circuit connected to the motor 29.

The controller 35 is configured to communicate with the electric actuator 21, the shifter 22, the motor 29, and the user operable input device 32 through an electric cable or a wireless communication device. By communicating with the electric actuator 21, the controller 35 can control the electric actuator 21 such that the rear derailleur 20a operates.

In a case where the shifter 22 is operated, a signal with respect to the shift operation is output to the controller 35. The controller 35 controls the electric actuator 21 in accordance with the signal with respect to the shift operation. The controller 35 controls the electric actuator 21 in accordance with the signal with respect to the shift operation, thereby changing the gear ratio of the human-powered vehicle 1 in accordance with the shift operation by the rider.

By communicating with the motor 29, the controller 35 can control the motor 29 such that the motor output shaft 29a rotates. In a case where the motor output shaft 29a rotates, the motor driving force is transmitted to the one front sprocket 17a via the reduction gear 30 and the output shaft 26. As a result of the motor driving force being transmitted to the one front sprocket 17a, the chain 19 is driven.

The drive unit 24 has an assist mode in which a propulsion force is applied to the human-powered vehicle 1 and a non-assist mode in which a propulsion force is not applied to the human-powered vehicle 1. The controller 35 is configured to control the motor 29 in one of the assist mode and the non-assist mode.

In a case of controlling the motor 29 in the assist mode, the controller 35 controls the motor 29 such that a ratio of the motor driving force to the human-powered driving force becomes a predetermined ratio. In this specification, the ratio of the motor driving force to the human-powered driving force is referred to as an assist ratio. In a case of controlling the motor 29 in the non-assist mode, the controller 35 controls the motor 29 such that the propulsion force is not applied to the human-powered vehicle 1. The assist mode can include a plurality of assist modes. For example, the assist mode can include a first assist mode, a second assist mode in which a propulsion force higher than that of the first assist mode is readily applied, and a third assist mode in which a propulsion force higher than that of the second assist mode is readily applied.

In a case where the user operable input device 32 is operated, a signal with respect to the assist operation is output to the controller 35. The controller 35 switches the control of the motor 29 from one of the assist mode and the non-assist mode to the other of the assist mode and the non-assist mode, in accordance with the signal with respect to the assist operation. In a case where the assist mode includes the plurality of assist modes, the user operable input device 32 is configured to enable selection of one mode from the plurality of assist modes, and the non-assist mode. In the case where the assist mode includes the plurality of assist modes, the controller 35 controls the motor 29 in the one mode selected by the rider using the user operable input device 32.

The detection unit 36 is configured to communicate with the controller 35 via an electric cable or a wireless communication device. The detection unit 36 can output a signal corresponding to the detection information to the controller 35. The detection information includes information that changes with the traveling of the human-powered vehicle 1. For example, the detection information includes at least one of gear position information, pedaling information, speed information, inclination information, and acceleration information. Here, the detection unit 36 includes a plurality of sensors as describes below. However, the detection unit 36 can include at least one sensor that is configured to detect the detection information regarding a travel state of the human-powered vehicle 1. The term “sensor” as used herein refers to a hardware device or instrument designed to detect the presence or absence of a particular event, object, substance, or a change in its environment, and to emit a signal in response. The term “sensor” as used herein refers to hardware and does not include a human being.

The gear position information is information indicating a current gear position of the at least one transmission 20. In the present embodiment, the gear position information is information indicating a current gear position of the rear derailleur 20a. The pedaling information is information that changes in accordance with pedaling of the human-powered vehicle 1. For example, the pedaling information includes at least one of torque information, cadence information, and crank angle information.

The torque information is information that changes in accordance with a torque input to the human-powered vehicle 1. For example, the torque information includes at least one of information indicating the torque input to the human-powered vehicle 1, information indicating a power rate, and information indicating work. The power rate and the work are calculated using the torque and the cadence.

The cadence information is information that changes in accordance with a cadence of the human-powered vehicle 1. For example, the cadence information includes information indicating the cadence that is a number of revolutions per minute of the crank 10. The crank angle information is information that changes in accordance with an angle of the crank 10 of the human-powered vehicle 1. For example, the crank angle information includes information indicating a rotation angle of one of the pedals 10c, with a top dead center of the one pedal 10c set to 0°.

The speed information is information that changes in accordance with a vehicle speed of the human-powered vehicle 1. For example, the speed information includes at least one of information indicating the vehicle speed of the human-powered vehicle 1, information indicating a rotational speed of the front wheel 15, and information indicating a rotational speed of the rear wheel 16. The inclination information is information that changes in accordance with an inclination of the human-powered vehicle 1. For example, the inclination information includes at least one of information indicating an inclination of a travel path of the human-powered vehicle 1, and information indicating a pitch angle of the human-powered vehicle 1. The acceleration information is information that changes in accordance with acceleration of the human-powered vehicle 1. For example, the acceleration information includes at least one of first acceleration information indicating acceleration along the direction in which the human-powered vehicle 1 advances, and second acceleration information indicating acceleration along the vertical direction of the human-powered vehicle 1.

The detection unit 36 includes at least one sensor capable of detecting the detection information. For example, the detection unit 36 includes at least one of a pedal sensor 38 that detects the pedaling of the human-powered vehicle 1, a vehicle speed sensor 39 that detects the vehicle speed of the human-powered vehicle 1, and a tilt sensor 40 that detects the inclination of the human-powered vehicle 1. In the present embodiment, the detection unit 36 includes a gear position sensor 37, the pedal sensor 38, the vehicle speed sensor 39, the tilt sensor 40, and an acceleration sensor 41.

The gear position sensor 37 is configured to detect the current gear position of the at least one transmission 20. In the present embodiment, the gear position sensor 37 is configured to detect the current gear position of the rear derailleur 20a. Since the detection unit 36 includes the gear position sensor 37, the detection unit 36 can detect the gear position information, of the detection information.

The pedal sensor 38 includes a torque sensor 38a, a cadence sensor 38b, and a crank angle sensor 38c. The torque sensor 38a detects at least one of the torque input to the human-powered vehicle 1, the power rate, and the work. The torque sensor 38a is configured to detect a torque input to the crank arms 10b using, for example, a strain sensor, a magnetostrictive sensor, or a pressure sensor. The strain sensor can include at least one of a metal strain gauge and a semiconductor strain gauge. By including the torque sensor 38a, the detection unit 36 can detect the torque information included in the pedaling information, of the detection information.

The cadence sensor 38b detects the cadence of the human-powered vehicle 1. The cadence sensor 38b detects the cadence by, for example, detecting a magnet provided to the crankshaft 10a. The cadence sensor 38b includes a magnetic detection sensor, such as a reed switch or a Hall element. By including the cadence sensor 38b, the detection unit 36 can detect the cadence information included in the pedaling information, of the detection information.

The crank angle sensor 38c detects the angle of the crank 10. In the present embodiment, the crank angle sensor 38c detects the rotation angle of one of the pedals 10c. The crank angle sensor 38c includes a magnetic detection sensor that outputs a signal corresponding to a strength of a magnetic field. The crankshaft 10a or a power transmission path from the crankshaft 10a to the one front sprocket 17a is provided with an annular magnet in which a strength of a magnetic field varies in a circumferential direction. The crank angle sensor 38c is configured to detect the rotation angle of one of the pedals 10c in accordance with the strength of the magnetic field detected by the magnetic detection sensor. By including the crank angle sensor 38c, the detection unit 36 can detect the crank angle information included in the pedaling information, of the detection information.

The vehicle speed sensor 39 includes a magnetic detection sensor such as a reed switch or a Hall element, for example. The magnetic detection sensor can be attached to a chain stay of the frame 11 and detect a magnet attached to the rear wheel 16. The vehicle speed sensor 39 can detect the rotational speed of the rear wheel 16 in accordance with a result of detection of the magnet attached to the rear wheel 16 by the magnetic detection sensor. The magnetic detection sensor can be provided to the front fork 14 and detect a magnet attached to the front wheel 15. The vehicle speed sensor 39 can detect the rotational speed of the front wheel 15 in accordance with a result of detection of the magnet attached to the front wheel 15 by the magnetic detection sensor. In the present embodiment, the vehicle speed sensor 39 is configured to detect the vehicle speed of the human-powered vehicle 1 on the basis of a result of detection of the rotational speed of one of the front wheel 15 and the rear wheel 16, and a tire circumferential length. By including the vehicle speed sensor 39, the detection unit 36 can detect the speed information, of the detection information.

The tilt sensor 40 includes, for example, a GPS reception unit provided to the human-powered vehicle 1. The GPS reception unit is configured to detect a current position of the human-powered vehicle 1. The tilt sensor 40 is configured to detect the inclination of the travel path on the basis of a signal output from the GPS reception unit and gradient information included in map information stored in advance in the storage unit 34. By including the tilt sensor 40, the detection unit 36 can detect the inclination information, of the detection information.

The acceleration sensor 41 detects the acceleration of the human-powered vehicle 1. For example, the acceleration sensor 41 detects at least one of the acceleration along the direction in which the human-powered vehicle 1 advances, and the acceleration along the vertical direction of the human-powered vehicle 1. In the present embodiment, the acceleration sensor 41 detects both the acceleration along the direction in which the human-powered vehicle 1 advances, and the acceleration along the vertical direction of the human-powered vehicle 1. For example, the tilt sensor 40 can detect the pitch angle of the human-powered vehicle 1 on the basis of the acceleration in the vertical direction detected by the acceleration sensor 41. By including the acceleration sensor 41, the detection unit 36 can detect the acceleration information, of the detection information.

In the present embodiment, the controller 35 is configured to switch between an automatic shift mode in which the rear derailleur 20a is automatically controlled in accordance with the detection information detected by the detection unit 36 and a manual shift mode in which the rear derailleur 20a is controlled in accordance with the shift operation by the rider. The human-powered vehicle 1 is provided with a mode operation device for switching from one of the automatic shift mode and the manual shift mode to the other of the automatic shift mode and the manual shift mode.

In order for the rear derailleur 20a to switch the chain 19 between the plurality of rear sprockets 18a, the chain 19 needs to be driven. In the manual shift mode, the shift operation is performed according to the intention of the rider. In a case where the shift operation is performed according to the intention of the rider, the rider basically operates the shifter 22 while pedaling the pedals 10c. In a case where the rider operates the shifter 22 while pedaling the pedals 10c, the motor 29 is controlled so as not to drive the chain 19 for gear shifting. The driving of the chain 19 for gear shifting will be described later.

In the case where the rider operates the shifter 22 while pedaling the pedals 10c, the electric actuator 21 operates the rear derailleur 20a so as to achieve a gear ratio corresponding to the operation of the shifter 22. In a case where the rear derailleur 20a operates in a state in which the chain 19 is not to be driven for gear shifting, a second shift operation not involving the driving of the chain 19 by the motor 29 is executed.

In the automatic shift mode, the gear ratio is changed even if the rider does not operate the shifter 22. In the automatic shift mode, in a case where the vehicle speed suddenly decreases, for example, the electric actuator 21 operates the rear derailleur 20a such that the gear ratio decreases. For example, in a case where the vehicle speed of the human-powered vehicle 1 suddenly decreases while traveling uphill, the electric actuator 21 operates the rear derailleur 20a such that the gear ratio decreases.

In the automatic shift mode, in a case where the vehicle speed of the human-powered vehicle 1 rapidly increases, for example, the electric actuator 21 operates the rear derailleur 20a such that the gear ratio of the human-powered vehicle 1 rises. For example, in a case where the rider pedals the pedals 10c while traveling on a flat road, causing the vehicle speed of the human-powered vehicle 1 to suddenly rise, the electric actuator 21 operates the rear derailleur 20a such that the gear ratio rises. The rider can easily cause the human-powered vehicle 1 to travel at a constant cadence by the gear ratio being adjusted by the operation of the rear derailleur 20a.

In the automatic shift mode, the rear derailleur 20a is operated regardless of the intention of the rider. In a case where the rear derailleur 20a is operated regardless of the intention of the rider, the pedals 10c may not be pedaled. For example, in a case where the human-powered vehicle 1 travels downhill and the human-powered vehicle 1 is decelerating, the pedals 10c may not be pedaled to an extent of being able to switch the chain 19 between the plurality of rear sprockets 18a, even though the gear ratio of the human-powered vehicle 1 is desirably changed. In a case where the pedals 10c are not pedaled, the motor 29 is controlled to drive the chain 19 for gear shifting.

The electric actuator 21 operates the rear derailleur 20a in a state in which the chain 19 is driven for gear shifting. In a case where the rear derailleur 20a operates in the state in which the chain 19 is driven for gear shifting, the first shift operation that involves the driving of the chain 19 by the motor 29 is executed.

As a result of the first shift operation being executed, the rear derailleur 20a can change the gear ratio of the human-powered vehicle 1 by switching the chain 19 between the plurality of rear sprockets 18a in a case where the pedals 10c are not pedaled. The first shift operation is executed at least in the automatic shift mode, of the manual shift mode and the automatic shift mode. Whether the first shift operation is executed in the manual shift mode can be selected in advance by the rider. In a case where the rider enables the execution of the first shift operation in advance, the first shift operation is executed in the manual shift mode. In a case where the rider prohibits the execution of the first shift operation in advance, the first shift operation can be prohibited in the manual shift mode.

In the automatic shift mode, the rear derailleur 20a can change the gear ratio of the human-powered vehicle 1 in accordance with the shift operation of the shifter 22. Since the gear ratio of the human-powered vehicle 1 can be changed in accordance with the shift operation, the rider can change the gear ratio of the human-powered vehicle 1 as desired in the automatic shift mode, thus improving convenience.

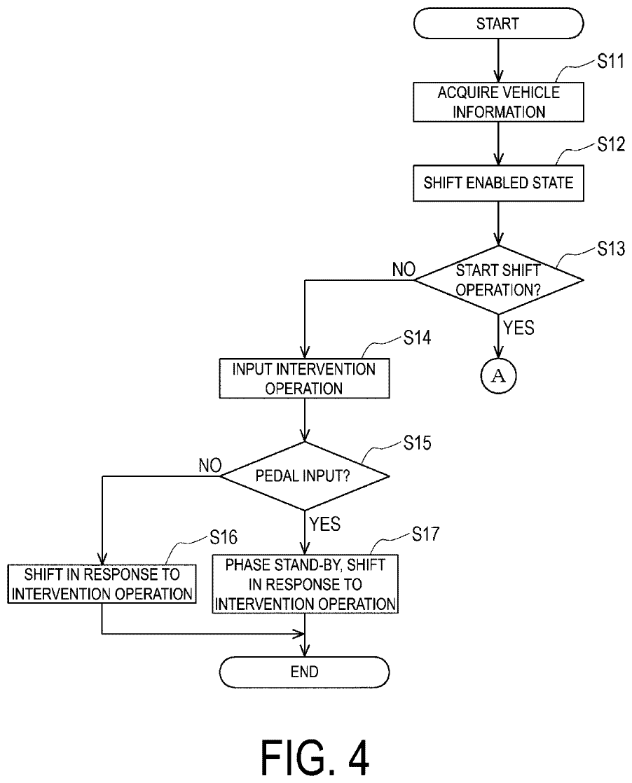

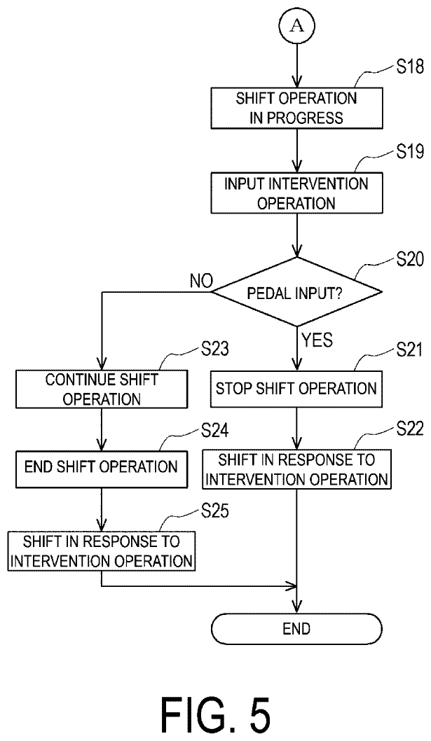

An example of control executed by the controller 35 will now be described. The example of the control executed by the controller 35 will be described with reference to FIGS. 4 and 5. The controller 35 is configured to execute a first control flow in accordance with a flowchart illustrated in FIGS. 4 and 5.

The controller 35 starts the first control flow in a case where a predetermined condition is satisfied. In the present embodiment, the controller 35 starts the first control flow in a case where the human-powered vehicle 1 is powered on. Upon the end of the first control flow, the controller 35 repeatedly executes the first control flow at a predetermined time interval. In the present embodiment, the controller 35 repeatedly executes the first control flow until the human-powered vehicle 1 is powered off.

As illustrated in FIG. 4, at step S11, the controller 35 acquires vehicle information. In the present embodiment, the controller 35 acquires the detection information detected by the detection unit 36. For example, the controller 35 acquires the current gear position of the rear derailleur 20a, the torque input to the human-powered vehicle 1, the power rate, the work, the cadence, the rotation angle of the one pedal 10c, the vehicle speed of the human-powered vehicle 1, the inclination of the travel path, the acceleration in the vertical direction, and the acceleration in the direction in which the human-powered vehicle 1 advances. Of the current gear position, the torque, the power rate, the work, the cadence, the rotation angle, the vehicle speed, the inclination, the acceleration in the vertical direction, and the acceleration in the direction in which the human-powered vehicle 1 advances, the controller 35 can acquire only some of the information necessary for processing from step S12 onwards. After performing the processing at step S11, the controller 35 proceeds to step S12.

In a case where, at step S12, the automatic shift mode is selected and the execution of the first shift operation is allowed, the controller 35 proceeds to step S13. In a case where, at step S12, the automatic shift mode is not selected until the predetermined condition is satisfied, the controller 35 ends the first control flow. For example, the controller 35 ends the first control flow in a case where the automatic shift mode is not selected before a predetermined time period elapses from proceeding to step S12. At step S13, the controller 35 determines whether a shift execution condition to start the first shift operation is satisfied.

The shift execution condition is satisfied in a case where the pedals 10c are not being pedaled during travel of the human-powered vehicle 1 and the current gear position is not appropriate. The state in which the pedals 10c are not pedaled during travel of the human-powered vehicle 1 is, for example, a state in which the vehicle speed acquired by the controller 35 at step S11 is equal to or greater than 3 kilometers per hour and the cadence acquired by the controller 35 at step S11 is less than 5 rpm.

In the present embodiment, a case where the current gear position is not appropriate means that the cadence required to achieve the current vehicle speed at the current gear position is a value at which the rider is unlikely to pedal comfortably. In a case where the pedals 10c are not pedaled during travel of the human-powered vehicle 1, since the rear wheel 16 is not rotating in accordance with the pedaling, an actual measurement value of the cadence acquired by the controller 35 at step S11 does not match a required cadence. In a case where the actual measurement value of the cadence acquired by the controller 35 does not match the required cadence, it is not possible to determine whether the current gear position is appropriate based on the actual measurement value of the cadence, and thus the controller 35 estimates the required cadence. In the present specification, the required cadence estimated by the controller 35 is described as an estimated cadence.

The estimated cadence is calculated in accordance with the vehicle speed and the cadence acquired by the controller 35 at step S11. The estimated cadence is calculated by, for example, the equation (1) below.

$$C = S * 1000 * RN / FN / T / 60 \qquad ( 1 )$$

The term C in equation (1) is the estimated cadence. The term S in equation (1) is the vehicle speed acquired by the controller 35 at step S11. The unit of S in equation (1) is per hour. The term RN in equation (1) is the number of teeth of the rear sprocket 18a corresponding to the current gear position acquired by the controller 35 at step S11. The number of teeth of the rear sprocket 18a corresponding to the current gear position is the number of teeth of the rear sprocket 18a with which the chain 19 is engaged. The term FN in equation (1) is the number of teeth of the one front sprocket 17a. The term T in equation (1) is the tire circumferential length of the human-powered vehicle 1. The unit of T in equation (1) is meters.

For example, in a case where the gear ratio of the human-powered vehicle 1 is maintained, the estimated cadence increases or decreases in accordance with the vehicle speed. In a case where the estimated cadence is outside a range of a predetermined threshold, the controller 35 determines that the current gear position is not appropriate. The controller 35 can determine whether the current gear position is appropriate in accordance with information other than the estimated cadence.

For example, the controller 35 can determine that the current gear position is not appropriate in a case where the torque input to the human-powered vehicle 1 has changed by a predetermined threshold or more. For example, the controller 35 can determine that the current gear position is not appropriate in a case where the vehicle speed of the human-powered vehicle 1 has changed by a predetermined threshold or more. For example, the controller 35 can determine that the current gear position is not appropriate in a case where the inclination of the travel path changes by a predetermined threshold or more. For example, the controller 35 can determine whether the current gear position is appropriate in accordance with a combination of two or more of the estimated cadence, the torque, the vehicle speed, and the inclination.

The shift execution condition is satisfied in a case where the pedals 10c are not being pedaled during travel of the human-powered vehicle 1 and the current gear position is not appropriate. In the present embodiment, the shift execution condition is satisfied in a case where the vehicle speed acquired by the controller 35 at step S11 is equal to or greater than 3 kilometers per hour, the cadence acquired by the controller 35 at step S11 is less than 5 rpm, and the estimated cadence is outside the range of predetermined threshold.

At step S13, in a case where the shift execution condition is satisfied, the controller 35 proceeds to step S18 illustrated in FIG. 5. In a case where the shift execution condition is not satisfied, the controller 35 proceeds to step S14 illustrated in FIG. 4.

After proceeding to step S14, the controller 35 proceeds to step S15 in a case where an intervention operation is input. The intervention operation is an operation for changing the gear ratio of the human-powered vehicle 1, and is interposed during the processing of the first control flow. In the present embodiment, the intervention operation includes a shift operation of the shifter 22. At step S14, the controller 35 ends the first control flow in a case where the intervention operation is not input before a predetermined condition is satisfied. For example, the controller 35 ends the first control flow in a case where the intervention operation is not input before a predetermined time period elapses after proceeding to step S14.

At step S15, the controller 35 acquires the detection information from the detection unit 36, and determines whether the human-powered driving force has been input to the pedals 10c. In the present embodiment, the controller 35 determines whether an input condition is satisfied. The input condition is satisfied in a case where the human-powered driving force is detected or in a case where input of the human-powered driving force to the pedals 10c is predicted. The input condition is defined on the basis of the detection information acquired by the controller 35 at step S15. In the present embodiment, the input condition includes any one of a first input condition to a ninth input condition, or a combination of two or more thereof.

The first input condition is satisfied in a case where the torque value acquired by the controller 35 is equal to or greater than a predetermined threshold. The predetermined threshold can be, for example, 3 Nm. The second input condition is satisfied in a case where the cadence acquired by the controller 35 is equal to or greater than a predetermined threshold. The predetermined threshold can be, for example, 3 rpm. The third input condition is satisfied in a case where the crank angle acquired by the controller 35 is less than a predetermined threshold. The predetermined threshold can be, for example, 30°. The fourth input condition is satisfied in a case where the power rate acquired by the controller 35 is equal to or greater than a predetermined threshold. The predetermined threshold can be, for example, 3 watts.

The fifth input condition is satisfied in a case where the work acquired by the controller 35 is equal to or greater than a predetermined threshold. The predetermined threshold can be, for example, 3 joules. The sixth input condition is satisfied in a case where the vehicle speed acquired by the controller 35 is equal to or greater than a predetermined threshold. The predetermined vehicle speed can be, for example, 3 kilometers per hour. The seventh input condition is satisfied in a case where the inclination of the travel path acquired by the controller 35 is equal to or greater than a predetermined threshold. The predetermined threshold can be, for example, −3%.

The eighth input condition is satisfied in a case where the acceleration in the direction in which the human-powered vehicle 1 advances, which is acquired by the controller 35, is equal to or greater than a predetermined threshold. The predetermined threshold can be, for example, +1 km/h/s. The ninth input condition is satisfied in a case where the acceleration in the vertical direction of the human-powered vehicle 1, which is acquired by the controller 35, is equal to or greater than a predetermined threshold. The predetermined threshold can be, for example, 5 G.

In the present embodiment, the input condition is satisfied in a case where all of the second input condition, the third input condition, and the sixth input condition are satisfied. In a case where the input condition is satisfied, the controller 35 proceeds to step S17. In a case where the input condition is not satisfied, the controller 35 proceeds to step S16.

At step S16, the controller 35 controls the motor 29 in order to drive the chain 19. In a case where the chain 19 is driven, the controller 35 controls the rear derailleur 20a so as to immediately perform the shift operation in response to the intervention operation, without standing by until the plurality of rear sprockets 18a reach predetermined phases. The predetermined phase is a phase at which it is easy for the rear derailleur 20a to switch the chain 19 between the plurality of rear sprockets 18a in a case where the rear derailleur 20a starts the shift operation.

By the control of the rear derailleur 20a at step S16, the chain 19 is switched so as to have a gear position corresponding to the shift operation of the shifter 22. The gear ratio of the human-powered vehicle 1 is changed according to the intention of the rider, by switching the chain 19 to have a gear position corresponding to the shift operation. After performing the processing at step S16, the controller 35 ends the first control flow.

At step S17, the controller 35 stands by until the plurality of rear sprockets 18a reach the predetermined phases. In a case where the plurality of rear sprockets 18a are in the predetermined phases, the controller 35 starts the shift operation of the rear derailleur 20a in response to the intervention operation.

At step S17, the shift operation is started in a case where the plurality of rear sprockets 18a are in the predetermined phases, and thus, the rear derailleur 20a can easily switch the chain 19. Since the rear derailleur 20a can easily switch the chain 19 at step S17, an impact is reduced in the shift operation in a case where a relatively high human-powered driving force is input to the pedals 10c. After performing the processing at step S17, the controller 35 ends the first control flow.

At step S13, in a case where the shift execution condition for starting the first shift operation is satisfied, the controller 35 proceeds to step S18 illustrated in FIG. 5. In processing from step S18 onward, the controller 35 starts execution of the first shift operation, to automatically change the gear ratio in accordance with the detection information. In a case where the shifter 22 is operated during execution of the first shift operation, a timing at which the gear ratio is automatically changed and a timing at which the rider manually changes the gear ratio overlap.

In the processing from step S18 onward, in a case where the shifter 22 is operated during the first shift operation, the controller 35 is configured to selectively stop or continue the driving of the motor 29 in accordance with a first detection result of the detection unit 36. By stopping the driving of the motor 29, the controller 35 stops the first shift operation and prioritizes the manual shift operation over the automatic shift operation. By continuing the driving of the motor 29, the controller 35 continues the first shift operation and prioritizes the automatic shift operation over the manual shift operation.

In the present embodiment, in a case where the first detection result is equal to or greater than a predetermined threshold, the controller 35 executes first processing that stops the driving of the motor 29 to stop the first shift operation, before performing the shift operation in response to an operation on the shifter 22 during the first shift operation. In a case where the first detection result is less than the predetermined threshold, the controller 35 executes second processing that continues the driving of the motor 29 to continue the first shift operation. In the present embodiment, the first processing includes processing at step S21 and step S22. The second processing includes processing from step S23 to step S25. The controller 35 can stop or continue the driving of the motor 29 in accordance with the first detection result, by executing the first processing in the case where the first detection result is equal to or greater than the threshold and by executing the second processing in the case where the first detection result is less than the threshold.

The first detection result is, for example, the detection information detected by the detection unit 36 subsequent to the operation of the shifter 22 during the first shift operation. The first detection result can also be, for example, the detection information detected by the detection unit 36 at a time point at which the shifter 22 is operated during the first shift operation. Of the detection information, the first detection result at least includes a detection result of information that is likely to increase in a case where an urgency to shift gear is high. The case where the urgency to shift gear is high is a case where it is desirable to quickly change the gear ratio.

For example, in a case where the vehicle travels on a steep uphill, it is desirable to quickly reduce the gear ratio. Thus, the first detection result can include the inclination of the travel path detected by the tilt sensor 40 subsequent to the operation of the shifter 22 during the first shift operation.

In a case where the rider wishes to change the gear ratio quickly, it is desirable to operate the rear derailleur 20a to change the gear ratio quickly. In the case where the rider wishes to change the gear ratio quickly, it is assumed that the pedals 10c will be pedaled in order for the rear derailleur 20a to be able to switch the chain 19. Since it is assumed that the rider will pedal the pedals 10c in the case where the rider wishes to quickly change the gear ratio, the first detection result can include pedaling detected by the pedal sensor 38 subsequent to the operation of the shifter 22 during the first shift operation. For example, the first detection result can include at least one of the torque detected by the torque sensor 38a, the cadence detected by the cadence sensor 38b, and the rotation angle of the one pedal 10c detected by the crank angle sensor 38c.

In a case where the rider pedals the pedals 10c, the vehicle speed and the acceleration of the human-powered vehicle 1 tend to increase. Thus, the first detection result can include at least one of the vehicle speed detected by the vehicle speed sensor 39 and the acceleration detected by the acceleration sensor 41 subsequent to the operation of the shifter 22 during the first shift operation.

By executing the first processing in the case where the first detection result is equal to or greater than the threshold, the controller 35 can quickly perform the shift operation in response to the operation on the shifter 22 in the case where the urgency to shift gear is high. Thus, by executing the second processing in the case where the first detection result is less than the threshold, in a case where the urgency to shift gear is low, the controller 35 can continue the first shift operation and automatically control the rear derailleur 20a to change the gear ratio of the human-powered vehicle 1. The processing from step S18 onward will now be described.

At step S18, the controller 35 controls the electric actuator 21 and the motor 29, thus performing the first shift operation to automatically change the gear ratio in accordance with the detection information. For example, in a case where the estimated cadence calculated by the controller 35 at step S13 illustrated in FIG. 4 is less than a lower limit of a predetermined range, the first shift operation is performed to decrease the gear ratio. For example, in a case where the estimated cadence calculated by the controller 35 at step S13 is greater than an upper limit of the predetermined range, the first shift operation is performed to increase the gear ratio.

At step S18 illustrated in FIG. 5, the controller 35 controls the motor 29 to drive the chain 19 for gear shifting. The controller 35 according to the present embodiment controls the motor 29 such that the motor driving force does not exceed a reference value. The reference value is, for example, a motor driving force required to achieve the vehicle speed acquired by the controller 35 at step S11. By controlling the motor 29 such that the motor driving force does not exceed the reference value, the motor 29 can drive the chain 19 to an extent at which the propulsion force is not applied to the human-powered vehicle 1 in a state in which the pedals 10c are not pedaled. Since the chain 19 can be driven to the extent at which the propulsion force is not applied to the human-powered vehicle 1, the motor 29 can drive the chain 19 such that the rear wheel 16 is not rotationally driven.

At step S19, in a case where the intervention operation is input during the first shift operation, the controller 35 proceeds to step S20. In the present embodiment, the intervention operation at step S19 is the operation of the shifter 22 during the first shift operation. At step S19, the controller 35 ends the first control flow in a case where the intervention operation is not input before the first shift operation is complete.

At step S20, the controller 35 acquires the detection result of the detection unit 36. In a case where the acquired detection result satisfies the input condition used at step S15, the controller 35 proceeds to step S21. In a case where the acquired detection result does not satisfy the input condition, the controller 35 proceeds to step S23. The detection result acquired by the controller 35 at step S20 is the first detection result detected by the detection unit 36 subsequent to the operation of the shifter 22 during the first shift operation.

At step S21, the controller 35 stops the driving of the motor 29 to stop the first shift operation. After performing the processing at step S21, the controller 35 proceeds to step S22. At step S22, the controller 35 controls the rear derailleur 20a to perform the shift operation in response to the intervention operation.

The rider may stop pedaling before the controller 35 proceeds from step S20 to step S22. Since it is difficult for the rear derailleur 20a to switch the chain 19 in a state in which the rider has stopped pedaling, at step S22, the controller 35 can control the motor 29 in accordance with the pedaling.

For example, at step S22, the controller 35 acquires the torque detected by the torque sensor 38a. In a case where the acquired torque is less than the predetermined threshold, the controller 35 performs first control for the case where the pedals 10c are not pedaled. In the first control, the controller 35 controls the motor 29 to drive the chain 19 for gear shifting. In a case where the acquired torque is equal to or greater than the predetermined threshold, the controller 35 performs second control for the case where the pedals 10c are pedaled. In the second control, the controller 35 controls the motor 29 to not drive the chain 19.

By controlling the motor 29 in accordance with the pedaling at step S22, depending on a second detection result detected by the detection unit 36, after stopping the first shift operation in the first processing, the controller 35 can perform the first shift operation in response to the operation on the shifter 22 during the first shift operation, or can perform the second shift operation in response to the operation on the shifter 22 during the first shift operation. The second detection result is, for example, a detection result of the detection unit 36 subsequent to the stopping of the first shift operation. The second detection result is, for example, the detection information acquired by the controller 35 from the detection unit 36 at step S22. The second detection result can be, for example, a detection result of the detection unit 36 at a time point at which the first shift operation is stopped.

The second detection result includes information, of the detection information, that can detect whether the pedals 10c are being pedaled. For example, the second detection result can include at least one of the torque detected by the torque sensor 38a, the cadence detected by the cadence sensor 38b, and the angle of the crank 10 detected by the crank angle sensor 38c subsequent to the stopping of the first shift operation.

At step S22, the chain 19 is driven by the motor 29 in the case where the pedals 10c are not being pedaled. Thus, the rear derailleur 20a can change the gear ratio. After performing the processing at step S22, the controller 35 ends the first control flow.

In a case where the input condition is not satisfied at step S20, the controller 35 proceeds to step S23. For example, the controller 35 proceeds to step S23 in the case where the pedals 10c are not being pedaled at step S20. At step S23, the controller 35 continues the first shift operation. In a case where the first shift operation is to be continued, the controller 35 proceeds to step S24. Upon completion of the first shift operation, the controller 35 proceeds from step S24 to step S25.

At step S25, the controller 35 controls the rear derailleur 20a to perform the shift operation in response to the intervention operation. As a result of the control of the rear derailleur 20a at step S25, in the second processing, subsequent to the completion of the first shift operation, the controller 35 can perform the shift operation by the at least one transmission 20 in accordance with the operation of the shifter 22 during the first shift operation. Since the shift operation can be performed in accordance with the operation of the shifter 22 during the first shift operation, the human-powered vehicle 1 travels at the gear ratio instructed by the rider, which can contribute to comfortable traveling of the human-powered vehicle 1.

Since the rider may stop pedaling before the controller 35 proceeds from step S20 to step S25, at step S25, the controller 35 can control the motor 29 in accordance with the pedaling.

For example, at step S25, the controller 35 acquires the torque detected by the torque sensor 38a. In a case where the acquired torque is less than the predetermined threshold, the controller 35 performs first control for the case where the pedals 10c are not pedaled. In the first control, the controller 35 controls the motor 29 to drive the chain 19 for gear shifting. In a case where the acquired torque is equal to or greater than the predetermined threshold, the controller 35 performs second control for the case where the pedals 10c are pedaled. In the second control, the controller 35 controls the motor 29 to not drive the chain 19.

By controlling the motor 29 in accordance with the pedaling at step S25, depending on a third detection result detected by the detection unit 36, after the completion of the first shift operation in the second processing, the controller 35 can perform the first shift operation in response to the operation on the shifter 22 during the first shift operation, or can perform the second shift operation in response to the operation on the shifter 22 during the first shift operation. The third detection result is, for example, a detection result of the detection unit 36 subsequent to the completion of the first shift operation. The third detection result is, for example, the detection information acquired by the controller 35 from the detection unit 36 at step S25. The third detection result can be, for example, a detection result of the detection unit 36 at a time point at which the first shift operation is completed.

The third detection result includes information, of the detection information, that can detect that the pedals 10c are being pedaled. For example, the third detection result can include at least one of the torque detected by the torque sensor 38a, the cadence detected by the cadence sensor 38b, and the angle of the crank 10 detected by the crank angle sensor 38c subsequent to the completion of the first shift operation.

At step S25, the chain 19 is driven by the motor 29 in the case where the pedals 10c are not being pedaled. Thus, the rear derailleur 20a can change the gear ratio. After performing the processing at step S25, the controller 35 ends the first control flow.

By executing the processing from step S18 onward of the first control flow, in a case where the pedals 10c are operated during the first shift operation, for example, the controller 35 can execute the first processing in a case where the first detection result of the detection unit 36 is equal to or greater than the predetermined threshold, and can execute the second processing in a case where the first detection result is less than the threshold. Since it is assumed that the rider pedals the pedals 10c in the case where the rider wishes to quickly change the gear ratio, by executing the processing from step S18 onward, the controller 35 can prioritize the manual shift operation over the automatic shift operation in the case where the rider wishes to quickly change the gear ratio. In the case where the rider wishes to quickly change the gear ratio, the intention of the rider can be respected and the gear ratio can be changed to the gear ratio instructed by the rider by prioritizing the manual shift operation. This can contribute to comfortable traveling of the human-powered vehicle 1.

### Second Embodiment

The control system 33 according to a second embodiment will be described. The control system 33 according to the second embodiment will be described with reference to FIGS. 4 to 6. Configurations common to those of the first embodiment will be denoted by the same reference signs as those of the first embodiment, and redundant descriptions thereof will be omitted.

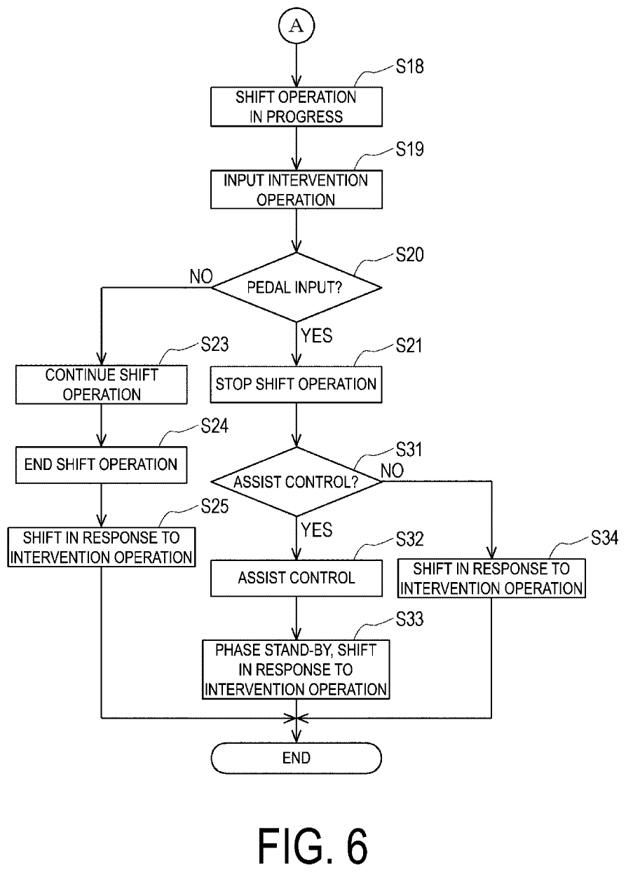

The controller 35 of the control system 33 according to the present embodiment is configured to execute a second control flow. The second control flow is different from the first control flow in processing from step S18 onward. The processing from step S18 of the second control flow onward is illustrated in FIG. 6. After stopping the first shift operation at step S21, the controller 35 proceeds to step S31.

At step S31, the controller 35 determines whether to perform assist control. The assist control is a control for applying a propulsion force to the human-powered vehicle 1 by the motor 29. The controller 35 determines that the assist control is to be performed in a case where an assist condition is satisfied. The assist condition is satisfied in a case where the propulsion force can be applied to the human-powered vehicle 1 by the motor 29 in a state in which the rider has selected an assist mode, from among the assist mode and a non-assist mode. The controller 35 acquires the detection information from the detection unit 36, and, depending on a first assist condition to a third assist condition, determines whether or the motor 29 can apply the propulsion force to the human-powered vehicle 1.

The first assist condition is satisfied in a case where the vehicle speed acquired by the controller 35 at step S31 is equal to or greater than a predetermined threshold. The predetermined threshold can be set in accordance with, for example, legal regulations. The predetermined threshold can be, for example, 25 kilometers per hour. The predetermined threshold can be, for example, 24 kilometers per hour. The predetermined threshold can be, for example, 45 kilometers per hour.

The second assist condition is satisfied in a case where the torque acquired by the controller 35 at step S31 is equal to or greater than a predetermined threshold. The third assist condition is satisfied in a case where the crankshaft 10a rotates in the first rotation direction. For example, by acquiring a history of the detection results of the crank angle of the crank 10 from the crank angle sensor 38c at step S31, the controller 35 can determine whether the crankshaft 10a rotates in the first rotation direction.

In the present embodiment, in a case where at least one of the first assist condition and the second assist condition is satisfied, the controller 35 determines that the propulsion force can be applied to the human-powered vehicle 1 by the motor 29. The controller 35 can determine that the propulsion force can be applied to the human-powered vehicle 1 by a determination different from that in the present embodiment. For example, the controller 35 can determine that the propulsion force can be applied to the human-powered vehicle 1 by the motor 29 in a case where all of the first assist condition, the second assist condition, and the third assist condition are satisfied. For example, the controller 35 can determine that the propulsion force can be applied to the human-powered vehicle 1 by the motor 29 in a case where both the first assist condition and the second assist condition are satisfied.

In a case where the rider selects the assist mode and the determination is made that the propulsion force can be applied to the human-powered vehicle 1 by the motor 29, the controller 35 proceeds to step S32. At step S32, the controller 35 performs the assist control. At the end of step S32, the controller 35 proceeds to step S33.

At step S33, similarly to step S17 illustrated in FIG. 4, the controller 35 stands by until the plurality of rear sprockets 18a reach the predetermined phases. In a case where the plurality of rear sprockets 18a are in the predetermined phases, the controller 35 starts the shift operation of the rear derailleur 20a in response to the intervention operation. As illustrated in FIG. 6, after performing the processing at step S33, the controller 35 ends the second control flow.

At step S34, the controller 35 controls the rear derailleur 18a to immediately perform the shift operation in response to the intervention operation, without waiting until the plurality of rear sprockets 20a reach the predetermined phases. At step S34, the controller 35 can control the motor 29 in accordance with the pedaling, similarly to step S22 illustrated in FIG. 5. As illustrated in FIG. 6, after performing the processing at step S34, the controller 35 ends the second control flow.

In a case where a relatively large torque is input to the human-powered vehicle 1 while the first shift operation is stopped by executing the second control flow, for example, the controller 35 controls the motor 29 such that the propulsion force is applied to the human-powered vehicle 1. By controlling the motor 29, in a case where a timing of the shift operation in response to the intervention operation and a timing of the application of the propulsion force overlap, the controller 35 can prioritize the assist control over the control of the shift operation.

### Modifications

The description with respect to each of the embodiments exemplifies applicable forms of the present invention with no intended limitation. The present invention is applicable to, for example, modifications of each of the embodiments, which will be described below, and combinations of at least two modifications that do not contradict each other.

For example, the configurations of the human-powered vehicle 1 and the configurations of the control system 33 in each of the embodiments are merely exemplary, and the configurations of the human-powered vehicle 1 and the control system 33 can include various devices not illustrated in each of the embodiments, or can be configured not to include some of the various devices illustrated in each of the embodiments.

For example, the human-powered vehicle 1 can include a drive source different from the motor 29 of the drive unit 24. The drive source that is different from the motor 29 can drive the chain 19 in a case where the first shift operation is performed.

The various thresholds used in the control exemplified in each of the embodiments are not limited, and can be configured as desired. The various thresholds can be changed as desired by operating a predetermined operation device or the like.

The processing contents and the order of processing of the flowcharts illustrated in each of the embodiment are examples, and the processing contents and the processing order can be changed as appropriate within the scope of the present invention. For example, at step S13 illustrated in FIG. 4, the controller 35 can determine that the shift execution condition is satisfied, in a case where the current gear position is not appropriate, in a state in which the pedals 10c are not being pedaled during travel of the human-powered vehicle 1 and in a state in which the propulsion force is not being applied to the human-powered vehicle 1 by the motor 29. The state in which the propulsion force is not being applied to the human-powered vehicle 1 by the motor 29 is, for example, a state in which the torque acquired by the controller 35 at step S11 is less than the predetermined threshold.

For example, at step S17 illustrated in FIG. 4 and at step S33 illustrated in FIG. 6, the controller 35 can control the rear derailleur 20a to perform the shift operation regardless of the phases of the plurality of rear sprockets 18a.

For example, at step S20 illustrated in FIG. 5, the controller 35 can determine whether the input condition is satisfied in accordance with the detection result of at least one of the pedal sensor 38, the vehicle speed sensor 39, and the tilt sensor 40. By the determination at step S20, the controller 35 can perform any one of the first processing and the second processing in accordance with the first detection result that includes the detection result of any one of the pedal sensor 38, the vehicle speed sensor 39, and the tilt sensor 40.

The phrase “at least one” as used in this specification means “one or more” of desired options. As one example, in a case where the number of options is two, the phrase “at least one” as used in this specification means “only one option” or “both of two options”. As another example, in a case where the number of options is three or more, the phrase “at least one” as used in this specification means “only one option” or “any combination of two or more options”.

What is claimed is:

1. A control system comprising:
at least one sensor configured to detect detection information regarding a traveling state of a human-powered vehicle; and
a controller configured to control a motor and at least one transmission,
the at least one transmission including a first shift operation involving driving of a chain by the motor, and
the controller being configured to selectively stop or continue driving of the motor in accordance with a first detection result of the at least one sensor in a case where a shifter is operated during the first shift operation.

2. The control system according to claim 1, wherein
the controller is configured to execute first processing of stopping the driving of the motor to stop the first shift operation before performing a shift operation in response to an operation of the shifter during the first shift operation in a case where the first detection result is equal to or greater than a predetermined threshold, and
the controller is configured to execute second processing of continuing the driving of the motor to continue the first shift operation in a case where the first detection result is less than the threshold.

3. The control system according to claim 2, wherein
the at least one transmission includes a second shift operation not involving the driving of the chain by the motor, and
after stopping the first shift operation in the first processing, the controller is configured to perform, in accordance with a second detection result detected by the at least one sensor, one of the first shift operation in response to an operation of the shifter during the first shift operation and the second shift operation in response to an operation of the shifter during the first shift operation.

4. The control system according to claim 2, wherein
in the second processing, after completion of the first shift operation, the controller is configured to perform the shift operation by the at least one transmission in response to an operation of the shifter during the first shift operation.

5. The control system according to claim 4, wherein
the at least one transmission includes a second shift operation not involving the driving of the chain by the motor, and
after completion of the first shift operation in the second processing, the controller is configured to perform, in accordance with a third detection result detected by the at least one sensor, one of the first shift operation in response to an operation of the shifter during the first shift operation and the second shift operation in response to an operation of the shifter during the first shift operation.

6. The control system according to claim 4, wherein
the at least one sensor includes at least one of a pedal sensor configured to detect pedaling of the human-powered vehicle, a vehicle speed sensor configured to detect a vehicle speed of the human-powered vehicle, and a tilt sensor configured to detect an inclination of the human-powered vehicle, and
the controller is configured to perform one of the first processing and the second processing in accordance with the first detection result of the at least one sensor.

7. A control system comprising:
at least one sensor configured to detect detection information regarding a traveling state of a human-powered vehicle; and
a controller configured to control a motor and at least one transmission,
the at least one transmission including a first shift operation involving driving of a chain by the motor, and
in a case where a pedal is operated during the first shift operation, and in a case where a first detection result of the at least one sensor is equal to or greater than a predetermined threshold, the controller is configured to execute first processing of stopping driving of the motor to stop the first shift operation before performing the shift operation by the at least one transmission in response to an operation of a shifter during the first shift operation, and
the controller is configured to executes second processing of continuing the driving of the motor and continuing the first shift operation in a case where the first detection result is less than the threshold.

8. The control system according to claim 7, wherein
the at least one sensor includes at least one of a pedal sensor configured to detect pedaling of the human-powered vehicle, a vehicle speed sensor that configured to detect a vehicle speed of the human-powered vehicle, and a tilt sensor configured to detect an inclination of the human-powered vehicle, and
the controller is configured to perform one of the first processing and the second processing in accordance with the first detection result including a detection result of at least one of the pedal sensor, the vehicle speed sensor, and the tilt sensor.

9. A human-powered vehicle comprising the control system according to claim 1, and further comprising:
a shifter operable by a rider;
a pedal;
a crank mounted with the pedal;
a front sprocket rotatable independently of the crank;
a rear wheel;
a rear sprocket rotatable independently of the rear wheel;
a chain meshing with the front sprocket and the rear sprocket;
a motor that drives the chain; and
at least one transmission that performs a shift operation including a first shift operation involving driving of the chain by the motor.
